(19) United States
(12) Patent Application Publication
(10) Pub. No.: US 2010/0328308 A1
(43) Pub. Date: Dec. 30, 2010

(54) Three Dimensional Mesh Modeling

(75) Inventors: Avihu Meir Gamliel, Pardes-Hana (IL); Shmuel Goldenberg, Ness-Ziona (IL); Felix Tsipis, Ma'alei Adomim (IL)

Correspondence Address: The Law Office of Michael E. Kondoudis, 888 16th Street, N.W., Suite 800, Washington, DC, 20006, US

(73) Assignee: C-TRUE LTD., Rehovot (IL)

(21) Appl. No.: 12/919,081

(22) PCT Filed: Jun. 24, 2009
(86) PCT No.: PCT/IB09/52706

§ 371 Date: Aug. 24, 2010

Related U.S. Application Data
(60) Provisional application No. 61/129,672, filed on Jul. 10, 2008.

(51) Int. Cl. G06T 17/00

(52) U.S. Cl. 345/420

(57) ABSTRACT

Apparatus for three dimensional mesh modeling, the apparatus comprising: a point cloud inputter, configured to input a point cloud generated using at least one sensor of a sensing device, the point cloud comprising a plurality of points, and a mesh model generator, associated with the point cloud inputter, configured to generate a mesh model from the point cloud, according to a plurality of projections of the points onto a geometrical surface the sensors are arranged on, each of the projections pertaining to a respective one of the points.

### FIELD AND BACKGROUND OF THE INVENTION

The present invention relates to three-dimensional modeling of real world objects and, more particularly, but not exclusively to an apparatus and method for generating three-dimensional mesh models for real world objects.

There is great interest in the development of computer systems which enable users to generate quickly accurate displays and reproductions of real world objects, terrains and other three dimensional surfaces.

A graphic display and manipulation system generates a mesh model of the object, terrain or surface, uses that mesh model as a basis to create the display or reproduction and allows the user to manipulate the model to create other displays such as morphs, fantasy displays or special effects. A mesh model represents an object, terrain or other surface as a series of interconnected planar shapes, such as sets of triangles, quadrangles or more complex polygons.

One of the most time consuming steps of three-dimensional mesh modeling of real world objects is surface reconstruction out of point clouds.

A point cloud is a cloud of points in a three dimensional space. The point cloud models physical location of sampled points on surfaces of a real world object, terrain, etc. The points represent actual, measured points on the object, surface, terrain, or other three dimensional surface. Typically, the number of the points in the point cloud is on a scale of a million.

There are several known methods for producing point clouds. Among the known methods there are Structured Light methods, Interferometry, Stereovision (also referred to as poly-vision), Shape from shading, Shape from video, etc.

Reference is now made to FIG. 1, which illustrates an exemplary structured light method, according to prior art.

In accordance with an exemplary currently used structured light method, a pattern is projected over an object, say a human face 101. Then, the object is scanned or photographed. Typically, the projected pattern is deformed by the object, since the object is not flat. Calculations based on the deformation of the pattern projected on the object, provide three dimensional data of the location of each scanned point, thus yielding a three dimensional point cloud.

With interferometry, coherent wavelength light is projected over the object. The light reflected back from the object is measured using one or more dedicated readers. A wrapped phase map is calculated, and unwrapped to yield a point cloud, as known in the art.

Stereovision methods utilize two or more cameras. Images of an object captured from the cameras are compared and analyzed, to produce three dimensional data of the location of each point on the surface of the object, thus yielding a point cloud.

In shape from shading methods, an object is lit from several directions. Shades of the object are compared and analyzed, to generate three dimensional data of the location of each point on the surface of the object, thus yielding a point cloud.

In shape from video methods (also referred to as shape from movement methods), video streams of an object which moves relative to one or more video camera(s), are used. Images of the video stream are compared and analyzed, to generate three dimensional data of the location of each point on the surface of the object, thus yielding a point cloud.

Reference is now made to FIG. 2, which illustrates an exemplary mash model, according to prior art.

Typically, the points of the point cloud include millions of randomly distributed points.

Point clouds themselves are generally not directly usable for three dimensional modeling applications, and are therefore usually converted to a mesh model. The mesh models allow viewing three dimensional point clouds as a surface constructed of multiple small triangles (or other polygons) having common edges.

One of the most time consuming steps of three-dimensional mesh modeling of real world objects is surface reconstruction of point clouds, which typically comprise millions of data points. The surface reconstruction is also referred to as surface triangulation, and meshing.

Surface triangulation is a process where neighboring points in the point cloud are connected, so as to reconstruct a surface for the real word object. That is to say that the surface of the object is reconstructed by connecting neighboring points of the point cloud, to form small triangles 201 (or other polygons). The triangles 201 are connected together by their common edges 202, thus forming a mesh model, as illustrated in FIG. 2.

Currently, the surface reconstruction process is typically carried out using CAD (Computer Aided Design) tools, or similar tools, in an extensive time and resource consuming process.

In a first step of the surface reconstruction process, the point cloud is searched, for finding closest neighboring points for each of the points in the three dimensional cloud. The neighboring points are selected carefully, so as to avoid finding too distant neighbors to a point (that may rather be isolated points that are better removed from the model), points separated by holes in the surface, points that appear neighboring because of misleading orientation of the object in the point cloud, etc.

Given the fact that a typical point cloud comprises millions of data points, this step is most extensive, with respect to time and resource consuming.

Next, the triangles (or other polygons) are formed by connecting each point with the neighboring points, thus forming multiple small triangles, connected together by their common edges, as illustrated using FIG. 2 hereinabove.

Finally, the triangles (or other polygons) are either pseudo-colored (i.e. assigned with arbitrary colors), using the CAD tools, or rendered to texture (say using a dedicated software tool, etc.). That is to say that each of the triangles (or other polygons) is assigned with a specific color or texture.

While pseudo-coloring is relatively simple, texture rendering is a complex task, which involves assigning realistic texture to the triangles (or other polygon), as known in the art.

Reference is now made to FIGS. 3A and 3B, which illustrate exemplary texture rendering, according to prior art.

In the exemplary texture rendering, a point cloud 301 captured from a face (say using a three dimensional scanner, as known in the art), is used to generate a mesh model 302 of the face, where each of the triangles is assigned realistic texture, say using skin color patterns found in a picture of a human face, as known in the art.

### SUMMARY OF THE INVENTION

According to one aspect of the present invention there is provided an apparatus for three dimensional mesh modeling, the apparatus comprising: a point cloud inputter, configured to input a point cloud generated using at least one sensor of a sensing device, the point cloud comprising a plurality of points, and a mesh model generator, associated with the point cloud inputter, configured to generate a mesh model from the point cloud, according to a plurality of projections of the points onto a geometrical surface the sensors are arranged on, each of the projections pertaining to a respective one of the points.

According to a second aspect of the present invention there is provided a method for three dimensional mesh modeling, the method comprising: inputting a point cloud generated using at least one sensor of a sensing device, the point cloud comprising a plurality of points, and generating a mesh model from the point cloud, according to a plurality of projections of the points onto a geometrical surface the sensors are arranged on, each of the projections pertaining to a respective one of the points.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 illustrates an exemplary structured light method, according to prior art.

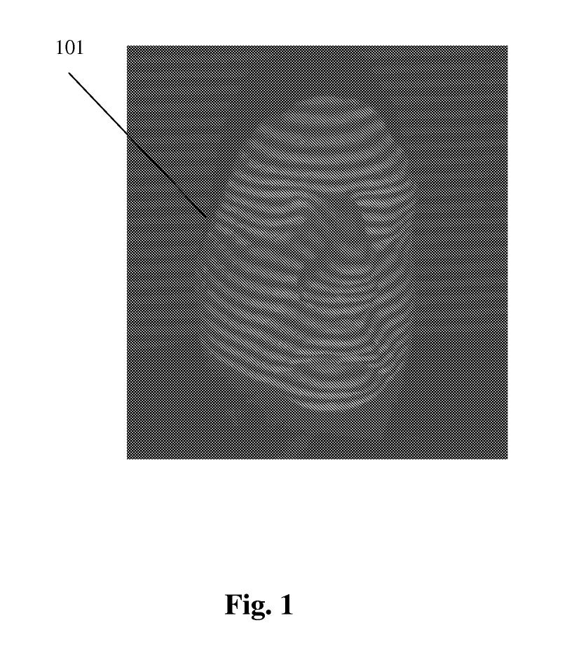

FIG. 2 illustrates an exemplary mash model, according to prior art.

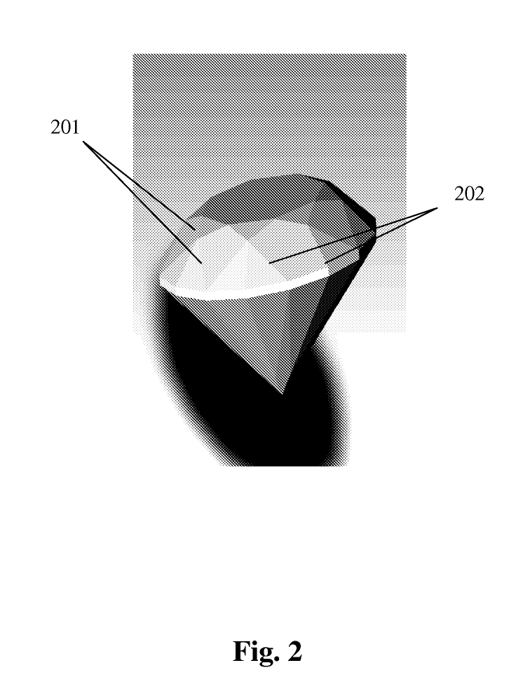

FIGS. 3A and 3B illustrate exemplary texture rendering, according to prior art.

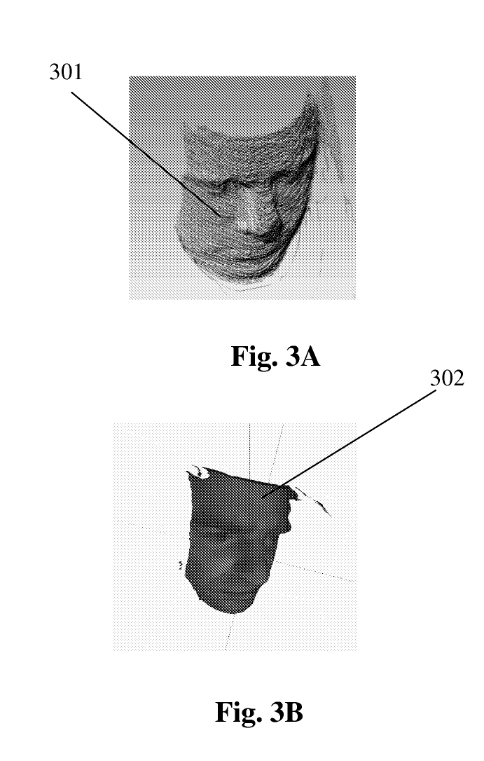

FIG. 4 is a block diagram illustrating an apparatus for three dimensional mesh modeling, according to an exemplary embodiment of the present invention.

FIG. 5 is a flowchart illustrating a first method for three dimensional mesh modeling, according to an exemplary embodiment of the present invention.

FIG. 6 is a flowchart illustrating a second method for three dimensional mesh modeling, according to an exemplary embodiment of the present invention.

FIG. 7 is a flowchart illustrating a three dimensional mesh modeling scenario, according to an exemplary embodiment of the present invention.

### DESCRIPTION OF THE PREFERRED EMBODIMENTS

The present embodiments comprise an apparatus and method for three dimensional mesh modeling (say for modeling a human face or another three dimensional object, a land terrain, etc.).

According to an exemplary embodiment of the present invention, a mesh model is generated from a point cloud.

A point cloud is a cloud of points in a three dimensional space. The point cloud models physical location of sampled points on surfaces of a real world object, say a human face, a land terrain, etc. The points represent actual, measured points on the human face or other three dimensional surface. Typically, the number of the points in the point cloud is on a scale of a million.

The generation of the mesh model is carried out according to projections of the cloud points onto a geometrical surface. The geometrical surface is a surface sensors used for generating the point cloud, are arranged on.

For example, using a structured light method, there may be used a camera having optical sensors arranged on a geometrical surface inside the camera, say on a plate inside the camera, beneath the lens of the camera, as known in the art.

The sensors capture a two dimensional image of a human face illuminated with light structured in a known pattern (say a pattern of stripes of alternating colors).

A three dimensional point cloud is generated using the image (which is two dimensional), and calculations based on distortions of the pattern on the human face, in the captured image.

The calculations yield a relation between each point in the point cloud and a corresponding point on the two dimensional image. The two dimensional image directly represents the human face, as captured by the sensors positioned on the geometrical surface. That is to say that the relation defines a projection of each of the cloud points on the geometrical surface the sensors are positioned on.

According to an exemplary embodiment, the projections of the cloud points onto the geometrical surface may be used as guidelines, for generating a mesh model from the point cloud.

In the exemplary embodiment, there is attempted to connect points in the point cloud (say in groups of three, to form triangles), in an order determined according to a degree of adjacency between the projections of the points on the geometrical surface.

For example, there may be carried out a raster like scan, through all projections (i.e. points or pixels) of the cloud points on the geometrical surface. In the raster-like scan, the projections are visited line by line, column by column, or through another order determined according to adjacency of projections on the geometrical surface. Through the scan, an attempt is made at connecting points in the cloud, which correspond to a projection visited and projections adjacent to the projection visited, to form a polygon. The polygon is verified against a predefined standard, as described in further detail hereinbelow.

The geometrical surface is two dimensional, whereas the point cloud is three dimensional. Consequently, connecting the points to form polygons in the order determined using the projections, is likely to be computationally simpler and faster than connecting the point in an order determined using the point cloud only.

Optionally, other factors are also taken into consideration for determining the order of connecting the point, say direction of connection, etc.

The projections may be used as guidelines, since the geometrical surface may represent a preferable point of view for the object captured in the point cloud (say, a direction an experienced photographer who operates the camera chooses for capturing the image of the human face).

The principles and operation of an apparatus and method according to the present invention may be better understood with reference to the drawings, and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

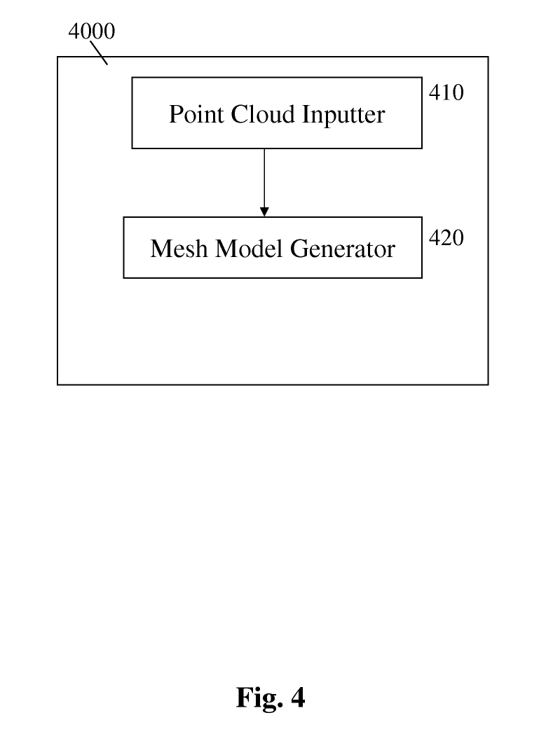

Reference is now made to FIG. 4, which is a block diagram illustrating an apparatus for three dimensional mesh modeling, according to an exemplary embodiment of the present invention.

Apparatus 4000 for three dimensional mesh modeling includes a point cloud inputter 410.

The point cloud inputter 410 inputs a point cloud. The point cloud is generated using one or more sensor(s) of a sensing device (such as a camera having several optic sensors arranged on a surface inside the camera, a three dimensional scanner, etc.), as known in the art and described in further detail hereinabove.

For example, the point cloud inputter 410 may receive a point cloud generated using two or more cameras in Stereovision, or a point cloud generated using a three dimensional scanner, as described in further detail hereinabove.

Apparatus 4000 further includes a mesh model generator 420, connected to the point cloud inputter 410.

The mesh model generator 420 generates a mesh model from the point cloud, according to projection(s) of each of the points in the cloud, onto a geometrical surface the sensors are arranged on, as described in further detail hereinbelow. Each of the projections pertains to a specific one of the cloud points.

Optionally, apparatus 4000 further includes a projection calculator, connected to the point cloud inputter 410.

The projection calculator calculates the projections of the cloud points onto the geometrical surface the sensors of the sensing device are arranged on, as described in further detail hereinbelow.

Optionally, the projection calculator calculates the projections according to information indicative of a spatial relation between the geometrical surface and the point cloud, as described in further detail hereinbelow.

For example, the point cloud may be input together with spatial information, which describes the spatial location of the sensing device (say a camera) or the sensors inside the sensing device. The spatial information further includes the spatial location of the point cloud (i.e. the spatial location of the object, face, or terrain represented by the cloud) in the real word. The projection calculator calculates the projections, using traditional methods which are commonly used for calculating the position of projections of points having known spatial positions onto a surface having a known spatial position, as known in the art.

Optionally, the spatial locations are defined using real world coordinates chosen for mapping the locations in a room where the cameras and the object captured in the point cloud are located.

Optionally, apparatus 4000 also includes a projection inputter, connected to the point cloud inputter 410.

The projection inputter inputs the projections of the points onto the geometrical surface the sensors are arranged on, say in a form of a table mapping between a position of each point in the point cloud and a position on the geometrical surface. The position on the geometrical surface represents the projection of the cloud point on the geometrical surface, as described in further detail hereinbelow.

Optionally, the apparatus 4000 further includes a point cloud generator, connected to the point cloud inputter 410.

The point cloud generator generates the point cloud.

The point cloud generator may include one or more components, such as one or more camera(s), a laser scanner, one or more light projectors (say for projecting a structured light on an object), and a processor for calculating the positions of the points in the three-dimensional point cloud, as known in the art.

The point cloud generator may use one or more of currently used methods for generating point clouds, including, but not limited to: Structured Light methods, Interferometry, Stereovision, Shape from shading, Shape from video, etc., as known in the art.

Optionally, the projection calculator calculates the projections of the points onto the geometrical surface the sensors are arranged on, substantial simultaneously to the generation of the point cloud by the point cloud generator, as described in further detail hereinbelow.

Optionally, the mesh model generator 420 connects three or more of the points, in an order determined by a degree of adjacency between the projections of the points on the geometrical surface. The points are connected to form one or more polygon(s) (say triangles), for generating the mesh model, as described in further detail hereinbelow.

Optionally, the mesh model generator 420 further verifies that the formed polygon complies with a predefined standard, say a standard pertaining to a distance between two or more of the points (which form the polygon) in the point cloud, as described in further detail hereinbelow.

Optionally, apparatus 4000 further includes a texture renderer.

The texture renderer is connected to the mesh model generator 420, and renders one or more of the polygons with a specific texture, as described in further detail hereinbelow.

Optionally, the texture renderer assigns a specific texture to each specific polygon, substantially simultaneously to the connection of the points by the mesh model generator 420, as described in further detail hereinbelow.

Optionally, the apparatus 4000 further includes a texture calculator, connected to the texture renderer.

The texture calculator calculates the texture, for each polygon. Optionally, the texture is calculated for each polygon using an image captured by the sensors for generating the point cloud, or an intensity map, as described in further detail hereinbelow. Optionally, the texture is calculated substantially simultaneously to generation of the mesh model by the mesh model generator 420.

Optionally, apparatus 4000 further includes a hole detector, connected to the mesh model generator 420.

The hole detector detects one or more holes in the point cloud, using the projections of the cloud points onto the geometrical surface the sensors are located on, as described in further detail hereinbelow.

Optionally, the hole detector detects the holes substantially simultaneously to generation of the mesh model by the mesh model generator 420, as described in further detail hereinbelow.

Optionally, apparatus 4000 further includes an island detector, connected to the mesh model generator 420.

The island detector detects one or more islands (i.e. groups of relatively isolated points) in the point cloud using the projections of the cloud points onto the geometrical surface the sensors are located on, as described in further detail hereinbelow.

Optionally, the island detector detects the islands substantially simultaneously to generation of the mesh model by the mesh model generator 420.

Optionally, apparatus 4000 further includes a portion filterer, connected to the mesh model generator 420.

The portion filterer filters one or more portions of the point cloud.

For example, the portion filterer may filter out one or more portions of the point cloud (say a single point significantly isolated from the rest of the cloud). The portion filterer filters out the portion, using the projections of the cloud points onto the geometrical surface the sensors are located on, as described in further detail hereinbelow.

Optionally, the portion filterer filters the portion(s) by processing the portion using graphical or geometrical filter techniques, say for improving smoothness, sharpness, etc., as described in further detail hereinbelow.

Optionally, the portion filterer filters out the portion(s) of the cloud, substantially simultaneously to generation of the mesh model by the mesh model generator 420.

Optionally, apparatus 4000 further includes a feature detector, connected to the mesh model generator 420.

The feature detector detects features on the point cloud (say a corner, a window, or an eyeball), as described in further detail hereinbelow. The feature detector detects the feature(s) using the projections of the cloud points onto the geometrical surface the sensors are located on, as described in further detail hereinbelow.

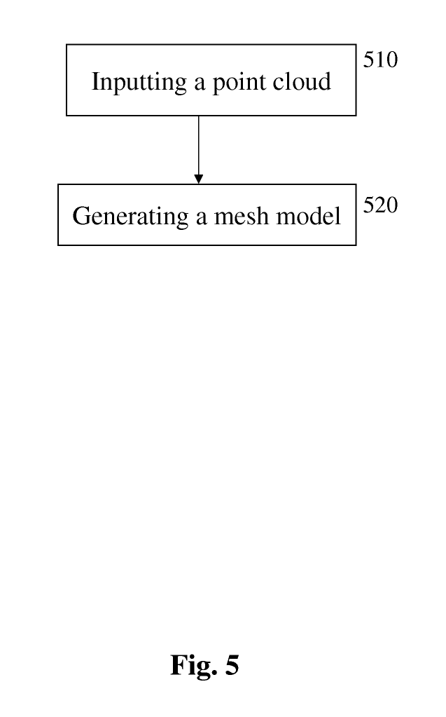

Reference is now made to FIG. 5, which is a flowchart illustrating a first method for three dimensional mesh modeling, according to an exemplary embodiment of the present invention.

In a method according to an exemplary embodiment of the present invention, there is input 510 a point cloud generated using one or more sensors of a sensing device, say by the point cloud inputter 410, as described in further detail hereinabove.

Typically, the point cloud includes millions of points, spatially distributed in the point cloud.

The sensing device may include, but is not limited to: a camera having several optic sensors deployed on a surface inside the camera, a three dimensional scanner, etc., as known in the art.

Next, there is generated 520 a mesh model from the point cloud, according to a projection of each of the cloud points onto a geometrical surface the sensors are arranged on, say by the mesh model generator 420, as described in further detail hereinabove. Each of the projections pertains to a specific one of the points.

Since each point in the point cloud is positioned in a three dimensional space, the point's projection on the geometrical surface is a point positioned in a two dimensional space (i.e. the geometrical surface).

The relation between the point in the point cloud and a corresponding point on the two dimensional geometrical surface where the sensors are positioned may be formulated using a table, such as Table 1 provided hereinbelow.

In Table 1, each cloud point is represented using coordinates values x, y, and z, which indicate the cloud point's real world position, as known in the art. Table 1 indicates the position of the cloud point's projection on the geometrical surface using coordinate values camera row and camera column, which correspond to lines and columns the camera sensors are arranged in, on the geometrical surface.

TABLE 1

| | | | | |
|---|---|---|---|---|
| Camera Row | Camera Column | X | Y | Z |

Optionally, the method further includes calculating the projections of the points onto the geometrical surface the sensors are arranged on, say using the projection calculator, as described in further detail hereinabove.

Optionally, the calculations of the projections are carried out according to information indicative of a spatial relation between the geometrical surface and the point cloud.

For example, the point cloud may be input together with spatial information, which describes the spatial location of the sensing device (say a camera) or the sensors inside the sensing device (i.e. on the geometrical surface). The spatial information further includes the spatial location of the point cloud (i.e. the spatial location of the object, face, or terrain represented by the cloud) in the real word. The calculations of the projections may be carried out using traditional methods which are commonly used for calculating the position of projections of points having known spatial positions onto a surface having a known spatial position, as known in the art.

Optionally, the spatial locations are defined using real world coordinates chosen for mapping the locations in a room (or other space) where the cameras and the object captured in the point cloud are located.

Once the spatial relation between the point cloud and the geometrical surface is known, the calculation of the projections of the points in the point cloud onto the two dimensional geometrical surface is a relatively simple mathematical task, carried out using traditional projection methods, as known in the art.

Optionally, the calculation of the projections further takes into consideration factors such as: calibration data (say of the camera), configurations, and other technical data, as known in the art. Information which pertains to the factors may be input together with the point cloud, separately (say by an operator of apparatus 4000), etc.

Optionally, the point cloud is input together with an intensity map, say a two dimensional image of the point cloud, as captured by the sensing device, say a camera, using the sensors, on the geometrical surface.

The intensity map characterizes each point on the surface, in a resolution dependent on the size and number of the sensors. The intensity map characterizes each point on the surface with respect to grey scale intensity (a single data item per a point on the geometrical surface), color (three data items per a point on the surface), etc., as known in the art.

The intensity map may be used for rendering portions (i.e. polygons) of the mesh model with realistic texture, as described in further detail hereinbelow.

Optionally, the method further includes inputting the projections of the points onto the geometrical surface the sensors are arranged on, say as a table, as described in further detail hereinabove.

Optionally, the method further includes generating the point cloud.

The point cloud generation may be carried out using one or more of currently used methods for generating point clouds, including, but not limited to: Structured Light methods, Interferometry, Stereovision, Shape from shading, Shape from video, etc., as described in further detail hereinabove.

Optionally, the generation of the point cloud is carried out substantial simultaneously to calculating the projections of the cloud points onto the geometrical surface the sensors are arranged on.

Optionally, the generation of the mesh model comprises connecting three (or more) of the points, in an order determined by degree of adjacency between the projections of the points on the geometrical surface, to form one or more polygons (say triangles), as described in further detail hereinbelow.

For example, there may be carried out a raster like scan, through all projections (i.e. points or pixels) of the cloud points on the geometrical surface. In the raster-like scan, the projections are visited line by line, column by column, or through another order determined according to adjacency of projections on the geometrical surface. Through the scan, an attempt is made at connecting points in the cloud, which correspond to a projection visited and projections adjacent to the projection visited, to form a polygon.

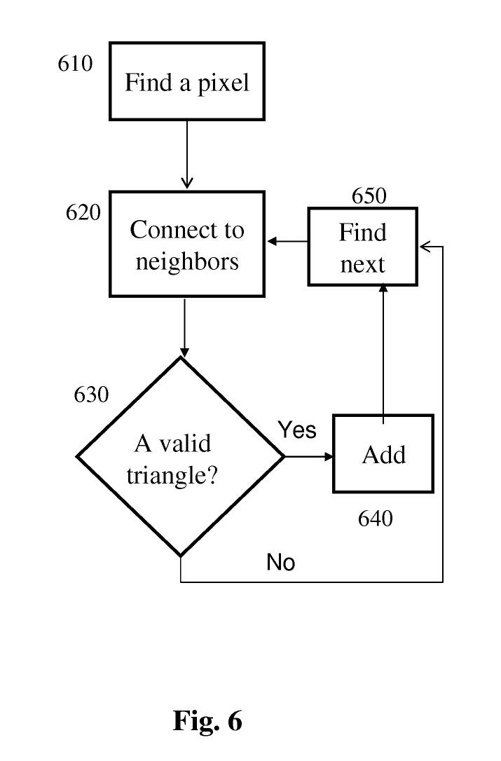

Optionally, it is further verified that the polygon complies with a predefined standard. The standard may pertain to a distance between two or more of the connected points in the point cloud, as described in further detail hereinbelow, and illustrated using FIG. 6.

Optionally, one or more of the polygons is rendered with a texture, specific to the polygon substantially in parallel to connecting the points, as described in further detail hereinbelow.

Optionally, the method further includes calculating the texture, using an image captured by the sensors for generating the point cloud, or an intensity map, as described in further detail hereinbelow.

Optionally, the calculation of the texture may be based on bilinear interpolation on intensity values corresponding to projections of the polygon's points onto the geometrical surface, using the intensity map, as known in the art.

Optionally, the rendering of the polygons with texture is carried in an order determined by an order determined according to degree of adjacency between the projections, as described in further detail hereinbelow.

Optionally, the rendering is carried out substantially in parallel to connecting the points

Optionally the method also includes detecting one or more holes in the point cloud.

The detection of the holes is carried out using the projections of the cloud points on the geometrical surface, for determining the order at which holes are searched for in the point cloud. (i.e. the order at which the cloud points are visited during the searching for the holes).

The geometrical surface is two dimensional, whereas the point cloud is three dimensional. Consequently, an order determined using the projections, is likely to be computationally simpler and faster than an order determined using the point cloud only.

Optionally, the detection of the hole(s) is carried out substantially simultaneously to generating the mesh model, say in parallel to connecting the cloud points.

Optionally, for detecting the holes in the point cloud, there are found free bounds in the mesh model. For example, if the points of the cloud are connected to form triangles, points which end up connected to a single triangle only, are free bounds, which may represent holes in the point cloud (i.e. also holes in a three dimensional object represented by the point cloud).

Optionally the method also includes detecting one or more islands in the point cloud.

The detection of the islands is carried out using the projections of the cloud points on the geometrical surface, for determining the order at which island are searched for in the point cloud. (i.e. the order at which the cloud points are visited during the searching for the islands).

The geometrical surface is two dimensional, whereas the point cloud is three dimensional. Consequently, an order determined using the projections, is likely to be computationally simpler and faster than an order determined using the point cloud only.

Optionally, the detection of the island(s) is carried out substantially simultaneously to generating the mesh model, say in parallel to connecting the cloud points.

Optionally, the detection the islands in the point cloud, like the detection of holes, is based on free bounds found in the mesh model.

An analysis of the polygons surrounding the suspected hole or island may indicate if the free bound marks a hole, or rather an island. Typically, a hole is an open area surrounded by polygons, whereas an island includes one or more adjacent polygons, which are relatively distant from other polygons in the mesh model.

Optionally the method also includes filtering one or more portions of the point cloud.

For example, the filtering may include filtering out the portions, say by deciding whether to remove an island (or even a single point, a couple of points, etc.) found in the point cloud out of the mesh model. The island is filtered out, say because the island represents a portion which does not belong to a three dimensional object in interest (say a bee flying over a human face of interest, the face represented by the point cloud).

The detection of the holes is carried out using the projections of the cloud points on the geometrical surface, for determining the order at which holes are searched for in the point cloud, as described in further detail hereinabove.

Consequently, the filtering out of one or more portions of the point cloud is also carried out using the projections. The filtering out is likely to become a computationally simpler and faster task than a task carried out in an order determined using the point cloud only, as described in further detail hereinabove.

Optionally, the filtering further includes processing the point cloud, using geometrical, or graphical filtering methods, for improving graphical smoothness, sharpness, etc., as known in the art.

Optionally the method also includes segmenting the point cloud. The segmentation of the point cloud includes mapping the point cloud into one or more segments. For example, the segmentation of the point cloud may involve deciding if certain islands are linked to each other (say islands that are relatively close, islands that are symmetric to each other), identifying a certain portion of the point cloud as a segment in accordance with a predefined criterion, say a that a certain portion of the point cloud, which has a significantly low density (i.e. occupied with fewer points than other portions of the cloud), represents a nose.

The detection of the islands is carried out using the projections of the cloud points on the geometrical surface, for determining the order at which islands are searched for in the point cloud, as described in further detail hereinabove.

Consequently, the segmentation of the point cloud is also carried out using the projections. Thus, the segmentation is also likely to become a computationally simpler and faster task than a task carried out in an order determined using the point cloud only, as described in further detail hereinabove.

Optionally the method also includes detecting one or more features in the point cloud. For example, the features may include an eyeball, a corner, a chair, etc.

Feature detection is widely used in areas such as face recognition, border security systems, alert systems, etc.

The detection of the features may be carried out using the projections of the cloud points on the geometrical surface.

For example, three-dimensional face recognition systems are believed much more effective than their two-dimensional counterparts, due to the fact that three dimensional geometrical properties are much more discriminative than two dimensional geometrical properties. On the other hand, feature localization in three dimensions is highly time and resources consuming.

One may choose to split feature detection into two major steps.

The first step involves rough two-dimensional localization of features using second-order statistic methods or any other method, as currently known in the art. The second-order statistic methods are applied on the projections of the points onto the geometrical surface of the sensors.

The second step involves a fast convergence numerical method for final feature localization, as known in the art. The fast convergence numerical method is based on results of the rough two-dimensional localization carried out in the first step. In the second step, the convergence numerical method is applied on a portion of the point cloud, located by de-projecting from an area located in the first step, on the geometrical surface into the cloud, say using Table 1, as described in further detail hereinabove.

Optionally, the methods described hereinabove implement super resolution techniques, as known in the art.

For example, a point cloud may be generated using two or more cameras. Projections of the cloud points may be calculated for each camera (i.e. for each cloud point's projection onto each geometrical surface of a specific camera's sensors). A well planned positioning of the cameras in relation to each other, may allow using the techniques on the cameras' geometrical surfaces in combination, to yield a mesh model having a higher resolution than each of the cameras alone, using super resolution calculation methods, as known in the art.

Reference is now made to FIG. 6, which is a flowchart illustrating a second method for three dimensional mesh modeling, according to an exemplary embodiment of the present invention.

As described hereinabove, an exemplary method includes verifying that the polygon formed by connecting the points in the point cloud, complies with a predefined standard.

For example, the standard may define a maximal distance between each pair of points in the cloud, connected to form the polygon.

Thus the method described hereinabove and illustrated using FIG. 5, may further include a second method, for verifying that the polygons (say triangles) comply with the predefined standard.

In the second method, there is carried out a scan over the projections of the cloud points onto the geometrical surface, in an order determined by degree of adjacency between the projections, as described in further detail hereinabove.

For each projection there is found 610 a corresponding point (or pixel) in the point cloud, say by de-projecting from a first projection on the geometrical surface, to a point (or pixel) in the point cloud. Optionally, the de-projection is carried out using Table 1, as described in further detail hereinabove.

The cloud point is connected 620 to points having projections adjacent, or in proximity to the first projection, to form a triangle or another polygon.

Next, there is verified 630 the compliance of the polygon with the predefined standard, which pertains to the distance between the points (or pixels) connected in the polygon, in the point cloud.

If the polygon complies with the standard, the polygon is added 640 to the mesh model.

Then, a second projection, adjacent to the previous one is visited, and de-projected to the cloud, to find 650 a point (or pixel) which corresponds to the second projection, and so on, until a mesh model is generated, (say until all projections are visited).

Optionally, the second method is carried out in accordance with the following exemplary pseudo-code.

In the exemplary pseudo-code, the point cloud is denoted PC. A two dimensional image captured by sensors arranged on a geometrical surface of a camera is denoted as I. Each of the points (or pixels) of the image I, which represent a projection of the cloud point on the geometrical surface is denoted Pix (_{I,j}), where _{I} and ⱼ denote the row and column position of the point in the image, respectively.

A function denoted Get3pnt, receives as input a pixel Pix (_{I,j}), and returns coordinate values x, y, and z, which indicate the position of a point corresponding to Pix (_{I,j}) in the point cloud, using Table 1, as described in further detail hereinabove.

A function denoted TestTriang, receives as input three cloud points. Each cloud point is input to TestTriang as three sub-parameters, which indicate the position of the point in the three dimensional cloud.

TestTriang returns a logic value indicating if the triangle formed by the three points input to TestTriang, complies with a predefined standard. For example, the standard may be a standard predefined by a user of apparatus 4000, and pertain to distances between the three point input to TestTriang.

The exemplary pseudo-code is as follows:

```
    For i = 1 To Image Height
    For j = 1 To Image Width
    Res = TestTriang (Get3DPnt ( pix(i,j) ), Get3DPnt (pix(i+1,j) ) ,
Get3DPnt (pix(i, j+1) ))
    If Res = Valid AddTrian2Surf( Get3DPnt( pixel(i,j) ), Get3DPnt
(pixel(i+1,j)) , Get3DPnt (pixel(i, j+1) ) )
    End // j
    End //I
```

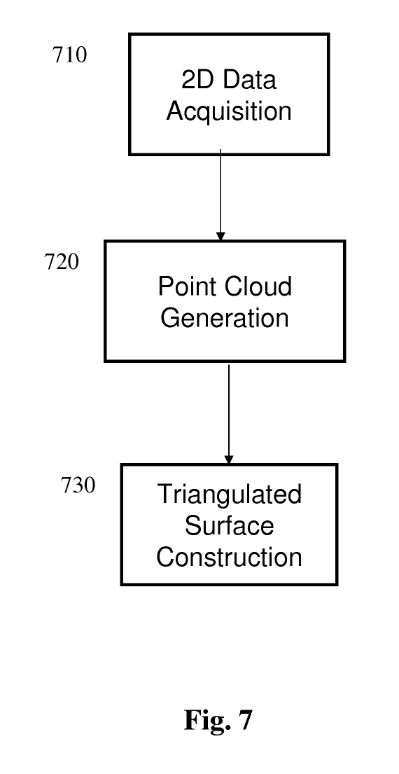

Reference is now made to FIG. 7, which is a flowchart illustrating a three dimensional mesh modeling scenario, according to an exemplary embodiment of the present invention.

In an exemplary scenario, two dimensional data (say a two dimensional image) acquired 710, say using a camera, by capturing a three dimensional object projected with structured light, as described in further detail hereinabove.

A point cloud is generated 720 using the two dimensional data. At least some of the points in the cloud represent the three dimensional image.

Inherent to the generation 720 of the point cloud, is a definition of a relation between the points in the cloud and the points (or pixels) of the two dimensional data, as described in further detail hereinabove.

The points of the two dimensional data are projections of the point clouds onto a geometrical surface the two dimensional data maps, say a geometrical surface the camera's sensors are arranged on.

Finally, the relation between the points in the cloud and the points (or pixels) of the two dimensional data (i.e. the projections) is used to generate a mesh model of the three dimensional object represented by the point cloud. The mesh model is generated by constructing 730 a triangulated surface from the point clouds.

The triangulated surface is constructed by connecting cloud points in an order determined according to adjacency among the projections, as described in further detail hereinabove.

It is expected that during the life of this patent many relevant devices and systems will be developed and the scope of the terms herein, particularly of the terms

“Camera”, “Image”, “Scanner”, “Structured Light”, “Interferometry”, “Stereovision”, “Shape from shading”, and “Shape from video”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications, and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. Apparatus for three dimensional mesh modeling, the apparatus comprising:
a point cloud inputter, configured to input a point cloud generated using at least one sensor of a sensing device, said point cloud comprising a plurality of points; and
a mesh model generator, associated with said point cloud inputter, configured to generate a mesh model from said point cloud, by connecting the points in a manner determined according to a positional relationship among a plurality of projections of said points onto a geometrical surface said sensors are arranged on, each of said projections pertaining to a respective one of said points.

2. The apparatus of claim 1, further comprising a projection calculator, associated with said point cloud inputter and configured to calculate said projections of said points onto said geometrical surface said sensors are arranged on.

3. The apparatus of claim 2, wherein said projection calculator is further configured to calculate said projections according to information indicative of a spatial relation between said geometrical surface and said point cloud.

4. The apparatus of claim 1, further comprising a projection inputter, associated with said point cloud inputter and configured to input said projections of said points onto said geometrical surface said sensors are arranged on.

5. The apparatus of claim 1, further comprising a point cloud generator, associated with said point cloud inputter and configured to generate said point cloud.

6. The apparatus of claim 1, further comprising a point cloud generator, associated with said point cloud inputter, configured to generate said point cloud, and a projection calculator, associated with said point cloud inputter, and configured to calculate said projections of said points onto said geometrical surface said sensors are arranged on, substantial simultaneously to said generation of said point cloud by said point cloud generator.

7. The apparatus of claim 1, wherein said mesh model generator is further configured to connect at least three of said points, in an order determined at least by degree of adjacency between said projections of said points on said geometrical surface, to form at least one polygon, for generating said mesh model.

8. The apparatus of claim 1, wherein said mesh model generator is further configured to connect at least three of said points, in an order determined at least by degree of adjacency between said projections of said points on said geometrical surface, to form at least one polygon, for generating said mesh model, provided said polygon complies with a predefined standard.

9. The apparatus of claim 8, wherein said predefined standard pertains to a distance between at least two of said connected points in said point cloud.

10. The apparatus of claim 7, further comprising a texture renderer, associated with said mesh model generator, configured to render at least one of said polygons with a respective texture, substantially simultaneously to connection of said points by said mesh model generator.

11. The apparatus of claim 10, further comprising a texture calculator, associated with said texture renderer, configured to calculate said texture, using an image captured by said sensors for generating said point cloud.

12. The apparatus of claim 1, further comprising a hole detector, associated with said mesh model generator, configured to detect a hole in said point cloud using said projections, substantially simultaneously to generation of said mesh model by said mesh model generator.

13. The apparatus of claim 1, further comprising an island detector, associated with said mesh model generator, configured to detect an island in said point cloud using said projections, substantially simultaneously to generation of said mesh model by said mesh model generator.

14. The apparatus of claim 1, further comprising a portion filterer, associated with said mesh model generator, configured to filter a portion of said point cloud using said projections, substantially simultaneously to generation of said mesh model by said mesh model generator.

15. The apparatus of claim 1, further comprising a segmentor, associated with said mesh model generator, configured to segment said point cloud using said projections, substantially simultaneously to generation of said mesh model by said mesh model generator.

16. The apparatus of claim 1, further a feature detector, associated with said mesh model generator, configured to detect a feature in said point cloud using said projections.

17. Method for three dimensional mesh modeling, the method comprising:
inputting a point cloud generated using at least one sensor of a sensing device, said point cloud comprising a plurality of points; and
generating a mesh model from said point cloud, by connecting the points in a manner determined according to a positional relationship among a plurality of projections of said points onto a geometrical surface said sensors are arranged on, each of said projections pertaining to a respective one of said points.

18. The method of claim 17, further comprising calculating said projections of said points onto said geometrical surface said sensors are arranged on.

19. The method of claim 18, wherein said calculating said projections is carried out according to information indicative of a spatial relation between said geometrical surface and said point cloud.

20. The method of claim 17, further comprising inputting said projections of said points onto said geometrical surface said sensors are arranged on.

21. The method of claim 17, further comprising generating said point cloud.

22. The method of claim 17, further comprising generating said point cloud and substantial simultaneously, calculating said projections of said points onto said geometrical surface said sensors are arranged on.

23. The method of claim 17, wherein said generating said mesh model comprises connecting at least three of said points, in an order determined at least by degree of adjacency between said projections of said points on said geometrical surface, to form at least one polygon.

24. The method of claim 17, wherein said generating said mesh model comprises connecting at least three of said points, in an order determined at least by degree of adjacency between said projections of said points on said geometrical surface, to form at least one polygon, provided said polygon complies with a predefined standard.

25. The method of claim 24, wherein said predefined standard pertains to a distance between at least two of said connected points in said point cloud.

26. The method of claim 23, further comprising rendering at least one of said polygons with a respective texture, substantially in parallel to connecting said points.

27. The method of claim 26, further comprising calculating said texture, using an image captured by said sensors for generating said point cloud.

28. The method of claim 17, further comprising detecting a hole in said point cloud, using said projections, substantially simultaneously to generating said mesh model.

29. The method of claim 17, further comprising detecting an island in said point cloud, using said projections, substantially simultaneously to generating said mesh model.

30. The method of claim 17, further comprising filtering a portion of said point cloud, using said projections, substantially simultaneously to generating said mesh model.

31. The method of claim 17, further comprising segmenting said point cloud, using said projections, substantially simultaneously to generating said mesh model.

32. The method of claim 17, further comprising detecting a feature in said point cloud, using said projections.
